(19) United States
(12) Patent Application Publication
(10) Pub. No.: US 2025/0106354 A1
(43) Pub. Date: Mar. 27, 2025

(54) INFORMATION PROCESSING APPARATUS, CONTROLLING METHOD THEREFOR, AND PROGRAM

(71) Applicant: Sony Interactive Entertainment Inc., Tokyo (JP)

(72) Inventors: Kenichiro YOKOTA, Tokyo (JP); Jin SATOH, Tokyo (JP); Masaki SASAKI, Tokyo (JP); Keisuke INOUE, Tokyo (JP)

(73) Assignee: Sony Interactive Entertainment Inc., Tokyo (JP)

(21) Appl. No.: 18/730,365

(22) PCT Filed: Jan. 20, 2023
(86) PCT No.: PCT/JP2023/001691

§ 371 Date: Jul. 19, 2024

(30) Foreign Application Priority Data
Jan. 31, 2022 (JP) 2022-013444

(51) Int. Cl. H04N 7/01; G06F 3/14; G06T 1/20

(52) U.S. Cl. CPC H04N 7/0127; G06F 3/14; G06T 1/20

(57) ABSTRACT

An information processing apparatus connected to a display apparatus capable of updating a frame image at a variable refresh rate executes a drawing process of a frame image, transmits the drawn frame image to the display apparatus, measures a drawing time period required for a drawing process of the frame image, and changes an operation condition of the drawing process according to the measured drawing time period.

### TECHNICAL FIELD

The present invention relates to an information processing apparatus that generates a video to be displayed on a screen of a display apparatus, a controlling method for the information processing apparatus, and a program.

### BACKGROUND ART

Generally, a display apparatus such as a domestic television receiver displays a video by continuously updating a still image (frame image) to be displayed on a screen in a predetermined cycle (refresh rate). Therefore, it is necessary for an information processing apparatus, which generates a video to be displayed on a display apparatus, to draw frame images constituting the video at a fixed frame rate adjusted to the refresh rate. However, there is a problem that, if the frame rate is fixed, the drawing performance of the information processing apparatus cannot be taken advantage of sufficiently, or conversely, in a case where the drawing performance of the information processing apparatus is insufficient, a disorder of display such as stuttering or tearing occurs.

Therefore, in a video standard such as the HDMI (registered trademark), a technology called variable refresh rate (VRR) in which the refresh rate of a display apparatus is made variable has been proposed. With this technology, since the display apparatus can update a display image at any refresh rate, the information processing apparatus can draw frame images at a more desirable frame rate by dynamically changing the frame rate according to a drawing speed of the information processing apparatus itself or the like.

### SUMMARY

### Technical Problem

In the technology described above, frame images are drawn efficiently by positively changing the frame rate. However, it has not been considered sufficiently as yet what control is to be performed to efficiently draw frame images in a case where the technology of the variable refresh rate is used.

The present invention has been made in view of such a situation as described above, and it is an object of the present invention to provide an information processing apparatus capable of efficiently executing a drawing process in a case where a video is to be displayed at a variable refresh rate, a controlling method for the information processing apparatus, and a program.

### Solution to Problem

An information processing apparatus according to an aspect of the present invention is an information processing apparatus connected to a display apparatus capable of updating a frame image at a variable refresh rate, the apparatus including a frame image drawing section that executes a drawing process of a frame image and transmits the drawn frame image to the display apparatus, a drawing time period measurement section that measures a drawing time period required for the drawing process of the frame image, and a drawing process controlling section that changes an operation condition for the drawing process according to the measured drawing time period.

An information processing method according to an aspect of the present invention is a controlling method for an information processing apparatus connected to a display apparatus capable of updating a frame image at a variable refresh rate, the method including a step of executing a drawing process of a frame image and transmitting the drawn frame image to the display apparatus, a step of measuring a drawing time period required for the drawing process of the frame image, and a step of changing an operation condition for the drawing process according to the measured drawing time period.

A program according to an aspect of the present invention is a program for causing a computer connected to a display apparatus capable of updating a frame image at a variable refresh rate, to execute a step of executing a drawing process of a frame image and transmitting the drawn frame image to the display apparatus, a step of measuring a drawing time period required for the drawing process of the frame image, and a step of changing an operation condition for the drawing process according to the measured drawing time period. The program may be provided in a state of being stored in a computer-readable non-transitory information storage medium.

### BRIEF DESCRIPTION OF DRAWINGS

FIG. 1 is a configuration block diagram depicting a general configuration of an information processing apparatus according to an embodiment of the present invention.

FIG. 2 is a functional block diagram depicting functions implemented by the information processing apparatus according to the embodiment of the present invention.

FIG. 3 is view illustrating an example of control executed by the information processing apparatus according to the embodiment of the present invention.

### DESCRIPTION OF EMBODIMENT

In the following, an embodiment of the present invention is described in detail with reference to the drawings.

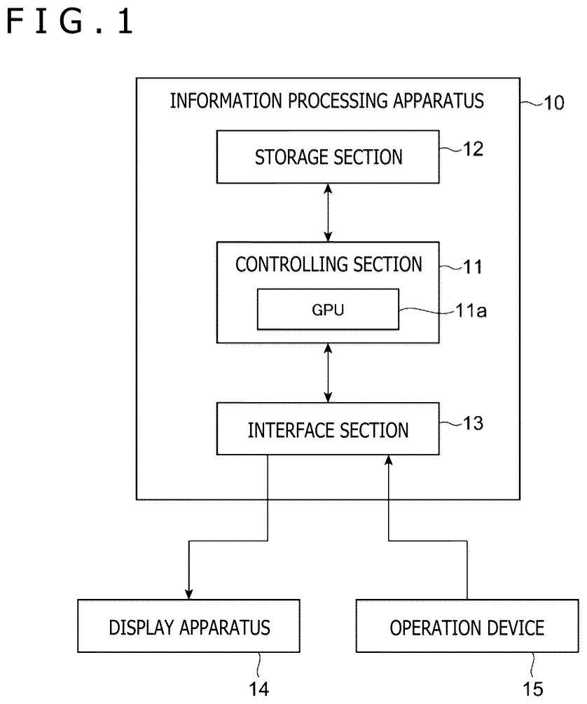

An information processing apparatus 10 according to the embodiment of the present invention is a domestic game machine, a personal computer, or the like and includes a controlling section 11, a storage section 12, and an interface section 13 as depicted in FIG. 1. Further, the information processing apparatus 10 is connected for data communication to a display apparatus 14 and an operation device 15.

The controlling section 11 includes at least one processor such as a CPU and executes a program stored in the storage section 12 to execute various types of information processing. Particularly, in the present embodiment, the controlling section 11 includes a GPU (Graphics Processing Unit) 11a used for an image drawing process. It is to be noted that a particular example of a process to be executed by the controlling section 11 in the present embodiment is hereinafter described. The storage section 12 includes at least one memory device such as a RAM and stores a program to be executed by the controlling section 11 and data to be processed by the program. Further, the storage section 12 includes a buffer memory that temporarily stores a frame image hereinafter described.

The interface section 13 is an interface for data communication with the display apparatus 14 and the operation device 15. The information processing apparatus 10 is connected to the display apparatus 14 and the operation device 15 individually in wired or wireless connection through the interface section 13. In particular, the interface section 13 includes a multimedia interface for transmitting a video signal supplied by the information processing apparatus 10 to the display apparatus 14. Especially, in the present embodiment, the interface section 13 includes an interface capable of transmitting a video signal in accordance with a standard supporting the variable refresh rate such as the HDMI. Further, the interface section 13 includes a data communication interface for receiving an operation signal indicative of contents of an operation input made by a user from the operation device 15. The interface section 13 may further include a communication interface for transmission and reception of data with some other computers through a communication network such as the Internet.

The display apparatus 14 is a domestic television receiver, a monitor apparatus for a personal computer, or the like and displays a video based on a video signal received from the information processing apparatus 10. Especially, in the present embodiment, the display apparatus 14 supports the variable refresh rate technology, and updates a frame image to be displayed on a screen, at a timing that is determined according to contents of a signal inputted thereto from the information processing apparatus 10. In other words, the display apparatus 14 can update a frame image to be displayed, not at a fixed refresh rate determined in advance but at a dynamically varying refresh rate.

The operation device 15 is a device for accepting an operation input made by the user of the information processing apparatus 10 and may be, for example, a controller for a domestic game machine, a keyboard, or a mouse. The operation device 15 includes operation members such as buttons and a touch pad for accepting an operation input made by the user and transmits an operation signal indicative of contents of the operation input made by the user to the operation members to the information processing apparatus 10.

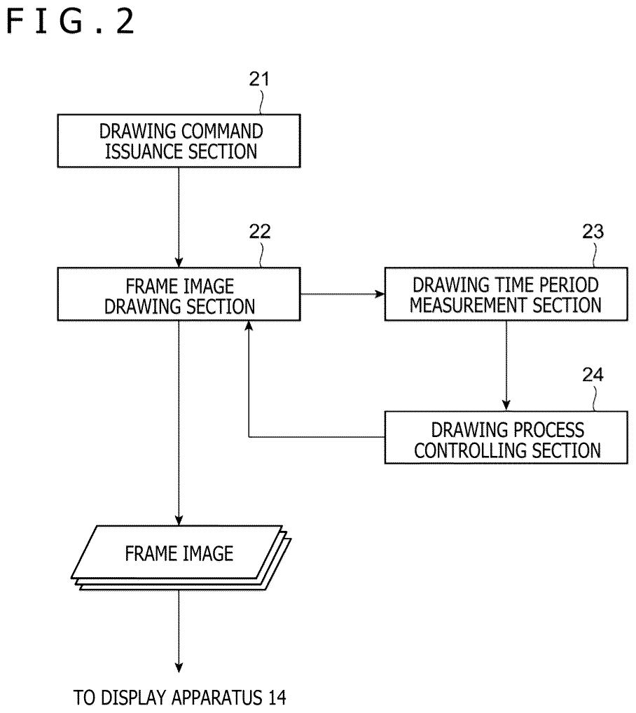

In the following, functions that are implemented by the information processing apparatus 10 in the present embodiment are described with reference to a functional block diagram of FIG. 2. As depicted in FIG. 2, the information processing apparatus 10 functionally includes a drawing command issuance section 21, a frame image drawing section 22, a drawing time period measurement section 23, and a drawing process controlling section 24. The functions are implemented by the controlling section 11 executing one or a plurality of programs stored in the storage section 12. The programs may be provided to the information processing apparatus 10 through a communication network such as the Internet or may be provided to the information processing apparatus 10 in a state of being stored in an information storage medium such as an optical disk.

The drawing command issuance section 21 determines contents of a frame image to be displayed on the screen of the display apparatus 14 and issues a drawing command for the determined contents to the frame image drawing section 22. The drawing command issuance section 21 is implemented by an application program such as a game program. As an example, in a case where a process of a game of the type in which a character is operated in a virtual space is to be executed, the drawing command issuance section 21 determines a position and a state of each of various objects to be disposed in the virtual space, a viewpoint position, and so forth and issues a drawing command to draw a situation of the virtual space.

The drawing command issuance section 21 successively executes a loop process to repeatedly issue such a drawing command for a frame image. Consequently, the frame image displayed on the screen of the display apparatus 14 is sequentially updated and presented as a video to the user. Since the display apparatus 14 supports the variable refresh rate as described above, the drawing command issuance section 21 need not issue a drawing command at regular intervals and can issue a drawing command for a frame image to be displayed next, suitably at a timing at which the frame image drawing section 22 ends drawing of a frame image.

The frame image drawing section 22 draws a frame image to be displayed on the screen of the display apparatus 14, in response to the drawing command received from the drawing command issuance section 21, and transmits a video signal including data regarding the drawn frame image to the display apparatus 14. The frame image drawing section 22 may be implemented by a program independent of the program that implements the drawing command issuance section 21, such as, for example, a graphic library or a game engine. Especially, in the present embodiment, at least part of the process of the frame image drawing section 22 is implemented by the GPU 11a. In other words, the GPU 11a executes at least part of an arithmetic process necessary for drawing of a frame image.

In the present embodiment, the frame image drawing section 22 executes drawing and transmission of a frame image at a variable frame rate. In particular, on completion of drawing of a frame image, the frame image drawing section 22 can immediately execute transmission of the drawn frame image to the display apparatus 14 and start drawing of a next frame image. It is to be noted that the drawing command issuance section 21 issues a drawing command for the next frame image, according to the timing at which the frame image drawing section 22 completes drawing of a frame image. Consequently, the drawing command issuance section 21 can keep issuing a drawing command in a cycle adjusted to a time period required for the frame image drawing section 22 to draw a frame image.

The drawing time period measurement section 23 measures, every time the frame image drawing section 22 draws a new frame image, a required time period (drawing time period) required for the drawing. In particular, the drawing time period measurement section 23 measures a time period starting from a point of time at which the frame image drawing section 22 completes drawing of a preceding frame image to a point of time at which drawing of a next frame image is completed, as a drawing time period required for drawing of the frame image.

The drawing process controlling section 24 controls an operation condition for a frame image drawing process executed by the frame image drawing section 22, on the basis of information regarding the drawing time period measured by the drawing time period measurement section 23. In a case where the drawing time period of the frame image is shorter than an assumed time period, it is expected that the processing performance of the GPU 11a has comparatively great room. Therefore, in such a case, the drawing process controlling section 24 changes the operation condition for the drawing process in such a manner as to suppress the drawing performance when the frame image drawing section 22 draws a next frame image. Generally, a tradeoff relation is established between the drawing performance and the power consumption when a frame image is drawn. Therefore, although suppression of the drawing performance increases the drawing time period of a frame image, it can reduce the power consumption required for the drawing. Conversely, in a case where the time period required for the drawing process of a frame image is longer than an assumed time period, the drawing process controlling section 24 changes the operation condition for the drawing process in such a manner as to enhance the drawing performance of the frame image drawing section 22, so that the time period required for drawing succeeding frame images can be shortened. With such control, the power consumption of the information processing apparatus 10 necessary for drawing of a frame image can be reduced while excessive reduction of the refresh rate of a video to be displayed on the display apparatus 14 is avoided.

In particular, the drawing process controlling section 24 determines a target time period Tx as a target value of the drawing time period of a frame image in advance. Then, every time the frame image drawing section 22 draws a frame image, the drawing process controlling section 24 compares the drawing time period with the target time period Tx and changes the operation condition for the drawing process in such a manner that, if the drawing time period is longer than the target time period Tx, the drawing performance is enhanced to reduce the drawing time period and that, if the drawing time period is shorter than the target time period Tx, the power consumption is reduced to increase the drawing time period. Consequently, control can be performed in such a manner that the drawing time period of each frame image approaches the target time period Tx.

The target time period Tx here may be a default value determined in advance. For example, in a case where a target refresh rate is 60 Hz, it is desirable that a frame image be transmitted to the display apparatus 14 once for approximately 16.6 ms (=1000 ms/60). In this case, the drawing process controlling section 24 determines 16.6 ms as the target time period Tx.

It is to be noted that the default value in this case may be changeable according to setting contents inputted in advance by the user or the like. Further, it may also be determined according to contents of a setting input made by the user or the like whether or not the drawing process controlling section 24 is to execute the control itself for changing the operation condition for the drawing process. In this case, the information processing apparatus 10 includes a function for accepting a designation of operation setting made by the user and retains the setting contents designated by the user into the storage section 12. Then, the drawing process controlling section 24 refers to the setting contents retained in the storage section 12 and determines, according to the contents, whether or not the control for changing the operation condition for the drawing process is to be executed or to what value the target time period Tx is to be set when the control is to be executed.

Assume that, as an example, in a case where the user selects in advance an operation mode for reducing the power consumption, the drawing process controlling section 24 executes the control for changing the operation condition for the drawing process, and in a case where the user conversely selects to turn off this operation mode, the drawing process controlling section 24 does not perform the operation control. Further, in a case where operation is to be performed in the operation mode for reducing the power consumption, the user will designate a value of 60 Hz, 120 Hz, or the like as the frame rate, and the drawing process controlling section 24 determines the target time period Tx according to the designated value of the frame rate.

As an alternative, the drawing process controlling section 24 may determine the target time period Tx according to an application program for implementing the drawing command issuance section 21 (i.e., an application program for determining contents of a frame image). There may be a case in which, in an application program that is an execution target, a specific value is assumed as a refresh rate for a display apparatus that displays a video. In this case, the drawing process controlling section 24 determines a time period corresponding to the refresh rate designated by the application program, as the target time period Tx. In particular, for example, the drawing process controlling section 24 may acquire the value of the refresh rate designated by the application program, by referring to setting information regarding the application program stored in the storage section 12 or accepting a notification from the application program itself being executed, such that the target time period Tx is determined according to the acquired value.

As another alternative, the drawing process controlling section 24 may determine the target time period Tx according to the type of an application program. For example, in a case where the application program is a game program, there is a difference in tendency of the required frame rate, according to the genre of the game. In particular, in the case of a game that requires real-time operability like an action game or a fighting game, it is desirable to update the frame image at a high frame rate. Meanwhile, in the case of a game in which real-time operability is not relatively important like a role playing game or a table game, there may be no problem even if a frame image is drawn at a frame rate lower by some degree. Therefore, in a case where such genre information regarding an application program can be acquired, the drawing process controlling section 24 may acquire genre information regarding an application program being executed and select a target time period Tx according to the acquired genre information as the target time period Tx to be applied in reality, from among target time periods Tx determined in advance for respective genres.

Further, the drawing process controlling section 24 may change the target time period Tx in real time on the basis of various conditions during execution of an application program. For example, the drawing process controlling section 24 may change the target time period Tx according to contents of an operation input made by the user. As a particular example, the drawing process controlling section 24 monitors presence or absence of an operation input made to the operation device 15 by the user and changes, in a case where operation inputting has not been performed for a fixed time period, the target time period Tx in such a manner as to decrease the frame rate to a given target value (for example, 48 Hz). Conversely, in a case where operation inputting has been performed, the target time period Tx is changed in such a manner as to increase the frame rate to a given target value (for example, 120 Hz). This makes it possible to reduce the frame rate to reduce the power consumption during a period when the user is not performing any operation to the application program.

Further, the drawing process controlling section 24 may change the target time period Tx according to presence or absence of a change of the frame image. As an example, the drawing process controlling section 24 calculates a hash value every time a frame image is newly drawn, and decides whether or not there is a change in the frame image by such a method as comparison of the hash value with the hash value calculated latest. Then, in a case where a state in which there is no change in the frame image continues for a predetermined time period or more, the drawing process controlling section 24 changes the target time period Tx in such a manner that the frame rate is decreased to a given target value (for example, 48 Hz). This makes it possible to decrease the drawing frequency of the frame image to reduce the power consumption in a case where there is no change in the frame image displayed on the display apparatus 14.

It is to be noted that, in a case where the target time period Tx is to be changed during execution of an application program as described above, the target time period Tx may be varied step by step by a predetermined variation amount, instead of being changed all at once, to a target value determined according to the situation.

Further, the above-described various references for determining the target time period Tx may be used in combination. For example, in a case where the target time period Tx is changed according to the contents of an operation input made by the user, a value determined in advance for each genre of an application program may be adopted as the target value. Further, a target value used in a case where the target time period Tx is varied in real time may be determined in such a manner as to be included within a range from an upper limit value to a lower limit value designated by the application program being executed.

In the following, a particular example of an operation condition for the drawing process that is to be controlled by the drawing process controlling section 24 is described. For example, the drawing process controlling section 24 may change an operation frequency of the GPU 11a as an example of an operation condition for the drawing process. In this case, the drawing process controlling section 24 decreases, when the drawing time period is shorter than the target time period Tx, the operation frequency of the GPU 11a but increases, when the drawing time period is longer than the target time period Tx, the operation frequency of the GPU 11a. It is known that, if the operation frequency of the GPU 11a is decreased, the power consumption of the GPU 11a can significantly be reduced. Therefore, by changing the operation frequency of the GPU 11a according to a required time period every time a frame image is drawn, the power consumption can be reduced when there is comparatively sufficient room in the drawing time period, while the drawing time period of a frame image can be made approach the target time period Tx.

As an alternative, the drawing process controlling section 24 may change, as an operation condition for the drawing process, the number of arithmetic units (the number of shaders, the number of cores, or the like) to be used for the drawing process of a frame image in the GPU 11a. Alternatively, the drawing process controlling section 24 may change the band width of a memory or the like. Otherwise, the drawing process controlling section 24 may change various parameters that have an influence on the drawing performance and the power consumption of the GPU 11a, according to the drawing time period.

Further, the drawing process controlling section 24 may determine the changing amount of a parameter relating to an operation condition for the drawing process, according to the magnitude of the difference between the drawing time period and the target time period Tx. In particular, the drawing process controlling section 24 changes a parameter relating to an operation condition by a larger amount as the difference between the drawing time period and the target time period Tx increases. This makes it possible to make, in a case where an actual time period required for drawing a frame image is significantly diverged from the target time period Tx, the actual time period quickly approach the target time period Tx.

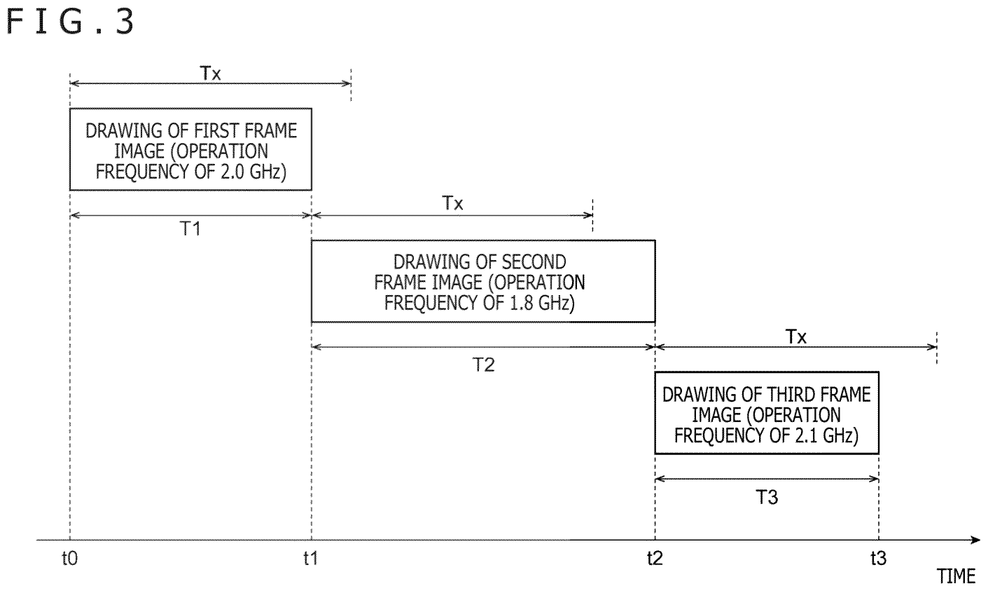

Here, a particular example of control to be executed by the information processing apparatus 10 according to the present embodiment is described with reference to FIG. 3. In FIG. 3, as an example, contents of control performed when three frame images are drawn after a reference time t0 set as a starting point are depicted.

In the example of FIG. 3, the frame image drawing section 22 first draws a first frame image at an operation frequency of 2.0 GHz of the GPU 11a. As a result, a drawing time period T1 required for the drawing of the first frame image is shorter than the target time period Tx. In response to this, the drawing process controlling section 24 decreases the operation frequency of the GPU 11a at a time t1 at which the drawing of the first frame image is completed. Here, as a particular example, the operation frequency of the GPU 11a is changed to 1.8 GHz.

In response to this change, the frame image drawing section 22 draws a second frame image at an operation frequency of 1.8 GHz of the GPU 11a. It is assumed that, as a result of the drawing, a drawing time period T2 of the second frame image exceeds the target time period Tx by a comparatively great amount. In response to this, the drawing process controlling section 24 increases the operation frequency of the GPU 11a at a time t2 at which the drawing of the second frame image is completed. Here, as a particular example, the drawing process controlling section 24 increases the operation frequency of the GPU 11a by a comparatively great amount, and as a result, a third frame image is drawn at 2.1 GHz which is higher than the operation frequency adopted when the first frame image is drawn. Consequently, the third frame image is drawn in a comparatively short drawing time period T3.

With such control as described above, it can be expected that each frame image is generally drawn in a drawing time period approximate to the target time period Tx. Meanwhile, even if a frame image is drawn in a drawing time period longer than the target time period Tx, since the display apparatus 14 updates the frame image at a variable refresh rate, frame images transmitted from the information processing apparatus 10 can be displayed sequentially without causing dropping of a frame.

As described above, with the information processing apparatus 10 according to the present embodiment, the power consumption necessary for drawing a frame image can be reduced without significantly decreasing the refresh rate when the display apparatus 14 displays a video, and therefore, an efficient drawing process can be achieved.

It is to be noted that the embodiment of the present invention is not restricted to that described above. For example, while such an operation parameter as an operation frequency of the GPU 11a is changed according to the drawing time period of a frame image in the foregoing description, any of other various operation conditions relating to a drawing process of a frame image may be changed. Further, a plurality of types of operation conditions may be changed in combination.

Further, in the foregoing description, every time a frame image is drawn, the operation condition for the drawing process is changed according to the drawing time period of the frame image. However, this is not restrictive, and the drawing process controlling section 24 may change, every time a plurality of frame images are drawn, the operation condition for the drawing process according to the overall time period required for the drawing process of the frame images. Alternatively, every time a plurality of frame images are drawn, the operation condition for the drawing process may be changed according to the time period required for the drawing process of the last frame image.

Further, in the foregoing description, the operation condition for the drawing process is changed in such a case that the drawing time period exceeds or falls below the target time period Tx even slightly. However, this is not restrictive, and the drawing process controlling section 24 may change the operation condition for the drawing process on the basis of a result of comparison between the drawing time period and a given threshold value determined according to the target time period Tx. In particular, for example, the drawing process controlling section 24 may decrease the performance of the drawing process in a case where the drawing time period exceeds a first threshold value determined according to the target time period Tx, and increase the performance of the drawing process in a case where the drawing time period falls below a second threshold value different from the first threshold value.

### REFERENCE SIGNS LIST

10: Information processing apparatus
11: Controlling section
11a: GPU
12: Storage section
13: Interface section
14: Display apparatus
15: Operation device
21: Drawing command issuance section
22: Frame image drawing section
23: Drawing time period measurement section
24: Drawing process controlling section

1. An information processing apparatus connected to a display apparatus capable of updating a frame image at a variable refresh rate, comprising:
a frame image drawing section that executes a drawing process of a frame image and transmits the drawn frame image to the display apparatus;
a drawing time period measurement section that measures a drawing time period required for the drawing process of the frame image; and
a drawing process controlling section that changes an operation condition for the drawing process according to the measured drawing time period.

2. The information processing apparatus according to claim 1, wherein the drawing process controlling section changes the operation condition for the drawing process according to a result of comparison between the measured drawing time period and a predetermined target time period.

3. The information processing apparatus according to claim 2, wherein the drawing process controlling section changes the operation condition for the drawing process according to a magnitude of a difference between the measured drawing time period and the target time period.

4. The information processing apparatus according to claim 2, wherein
the drawing process controlling section determines the target time period according to a value of a frame rate designated by an application program that determines contents of the frame image.

5. The information processing apparatus according to claim 2, wherein
the drawing process controlling section determines the target time period according to a type of an application program that determines contents of the frame image.

6. The information processing apparatus according to claim 2, wherein
the drawing process controlling section determines the target time period according to setting contents designated in advance by a user.

7. The information processing apparatus according to claim 2, wherein the drawing process controlling section changes the target time period during execution of an application program that determines contents of the frame image.

8. The information processing apparatus according to claim 7, wherein the drawing process controlling section changes the target time period according to contents of an operation input made by a user.

9. The information processing apparatus according to claim 7, wherein the drawing process controlling section changes the target time period according to a change of the frame image drawn by the frame image drawing section.

10. The information processing apparatus according to claim 1, wherein the frame image drawing section draws the frame image by arithmetic processing of a graphics processing unit, and
the drawing process controlling section changes an operation parameter of the graphics processing unit as an operation condition for the drawing process.

11. A controlling method for an information processing apparatus connected to a display apparatus capable of updating a frame image at a variable refresh rate, comprising:
executing a drawing process of a frame image and transmitting the drawn frame image to the display apparatus;
measuring a drawing time period required for the drawing process of the frame image; and
changing an operation condition for the drawing process according to the measured drawing time period.

12. A program for a computer connected to a display apparatus capable of updating a frame image at a variable refresh rate, comprising:
by a frame image drawing section, executing a drawing process of a frame image and transmitting the drawn frame image to the display apparatus;
by a drawing time period measurement section, measuring a drawing time period required for the drawing process of the frame image; and
by a drawing process controlling section, changing an operation condition for the drawing process according to the measured drawing time period.
